(19) United States
(12) Patent Application Publication
(10) Pub. No.: US 2025/0145135 A1
(43) Pub. Date: May 8, 2025

(54) BRAKE SYSTEM FOR A MOTOR VEHICLE AND ASSEMBLY FOR A BRAKE SYSTEM

(71) Applicant: Continental Automotive Technologies GmbH, Hannover (DE)

(72) Inventor: Harald Biller, Eschborn (DE)

(73) Assignee: Continental Automotive Technologies GmbH, Hannover (DE)

(21) Appl. No.: 18/837,582

(22) PCT Filed: Feb. 6, 2023
(86) PCT No.: PCT/DE2023/200026

§ 371 Date: Aug. 9, 2024

(30) Foreign Application Priority Data
Feb. 11, 2022 (DE) 10 2022 201 471.5

(51) Int. Cl. B60T 13/62; B60T 8/40; B60T 13/14; B60T 13/68; B60T 17/22

(52) U.S. Cl. CPC B60T 13/62; B60T 8/4081; B60T 13/142; B60T 13/148; B60T 13/686; B60T 17/22; B60T 2270/402; B60T 2270/404; B60T 2270/82

(57) ABSTRACT

A brake system for a motor vehicle, comprises a first assembly, in which a first electrically actuable pressure source and a master brake cylinder can be actuated by means of a brake pedal. A second assembly, in which a second electrically actuable pressure source and electrically actuable inlet valves are arranged for each wheel brake. The second electrically actuable pressure source being hydraulically connected to the inlet valves, wherein the first assembly comprises a single pressure port for transmitting brake pressure for actuating the wheel brakes to the second assembly. The first pressure source and the master brake cylinder are connected to the pressure port via a system pressure line.

### TECHNICAL FIELD

The embodiments related to a brake system and an assembly for a brake system for a motor vehicle.

### BACKGROUND

DE 10 2018 222 478 A1 discloses brake systems which comprise a brake-pedal-actuable master brake cylinder, two electrically controllable pressure sources and an inlet valve for each wheel brake, wherein the master brake cylinder and one of the electrically controllable pressure sources are arranged in a first assembly, and the other electrically controllable pressure source and the inlet valves are arranged in a second assembly. In this case, the first assembly and the second assembly are interconnected by at least two pressure-resistant hydraulic connecting elements. Correspondingly, the first assembly comprises two or more pressure ports, via which a brake pressure is transmitted from the first assembly to the second assembly to actuate the wheel brakes.

### SUMMARY

It is an object to provide an improved brake system and an improved assembly for a brake system for hydraulically actuable wheel brakes which can be produced in a cost-effective manner. Furthermore, the brake system for the highly automated driving should offer high availability.

Another object is to keep the number of hydraulic connections of the brake system, for example between the assemblies, and the number of hydraulic connections or ports of an assembly of the brake system to a minimum.

The brake system comprises a first assembly, in which a first electrically actuable pressure source and a master brake cylinder which can be actuated by means of a brake pedal are arranged, and comprises a second assembly in which a second electrically actuable pressure source and at least one electrically actuable inlet valve are arranged for each wheel brake, the second electrically actuable pressure source being hydraulically connected to the inlet valves. In this case, the first assembly comprises at most one pressure port for transmitting brake pressure for actuating the wheel brakes to the second assembly, the first pressure source and the master brake cylinder being connected to this pressure port via a system pressure line. In other words, the first pressure source and the master brake cylinder are jointly connected to a single pressure port of the first assembly.

Therefore, by means of the two electrically actuable pressure sources, highly automated driving is possible, and a mechanical/hydraulic fallback mode is also provided in case of total electrical failure. In this case, due to the low number of ports of the individual assemblies/hydraulic connections, the brake system can be produced in a cost-effective manner.

The brake system is configured for at least two hydraulically actuable wheel brakes for a motor vehicle. For example, it is a brake system for at least four hydraulically actuable wheel brakes. The second assembly then comprises at least one electrically actuable inlet valve per wheel brake, wherein the second electrically actuable pressure source is hydraulically connected to the at least four inlet valves.

The brake system comprises a pressure medium reservoir which is under atmospheric pressure. The pressure medium reservoir may be arranged on the first assembly.

The brake system comprises one outlet valve per wheel brake, by means of which valve each wheel brake is connected to the pressure medium reservoir.

All the inlet valves may be connected to the single pressure port of the first assembly. Thus, all the inlet valves can be actuated either by means of the first electrically actuable pressure source or by means of the master brake cylinder.

The first pressure source and the master brake cylinder may be connected to the pressure port via the system pressure line inside the first assembly.

According to one development of the brake system, the first assembly and the second assembly may be interconnected by at most one pressure-resistant hydraulic connecting element, the pressure-resistant hydraulic connecting element being connected to the pressure port of the first assembly.

All the inlet valves may be connected to a brake supply line which is arranged in the second assembly, the brake supply line being connected to the single pressure port of the first assembly, in particular via the pressure-resistant hydraulic connecting element.

The first assembly may be connected in a pressure-resistant manner to the second assembly only via the pressure port.

The first pressure source may be connected to the pressure port in such a way that, in the case of a failure of the first pressure source, no pressure medium can flow into this connection.

The first pressure source may be connected to the system pressure line via an electrically actuable sequence valve arranged in the first assembly. The sequence valve may be configured to be normally closed.

The pressure port can be connected to the pressure medium reservoir. For example, the pressure port can be connected to the pressure medium reservoir via the master brake cylinder.

According to one development of the brake system, when the brake pedal is not actuated, and the first assembly is de-energized, the pressure port is connected to the pressure medium reservoir. For example, when the brake pedal is not actuated, and the first assembly is de-energized, the pressure port is connected to the pressure medium reservoir via the master brake cylinder. In such a situation, the pressure port and thus the connected wheel brakes are thus depressurized.

The master brake cylinder comprises at least one expansion port, via which a pressure chamber of the master brake cylinder is connected to the pressure medium reservoir when the brake pedal is not actuated.

The master brake cylinder or the pressure chamber thereof may be connected to the system pressure line or the pressure port via an electrically actuable separation valve which is arranged in the first assembly. For example, the separation valve is configured to be normally open in order to ensure the connection to the pressure medium reservoir when the first assembly is de-energized.

A simulator which is hydraulically connected to the master brake cylinder may be arranged in the first assembly. The simulator provides the driver with a brake pedal feel in a by-wire operating mode.

The master brake cylinder may be connected to the simulator via an electrically actuable simulator valve. The simulator valve may be arranged in the first assembly. The simulator valve may be configured to be normally closed so that, when the first assembly is de-energized, the simulator is switched off and cannot receive any pressure medium.

The first assembly may additionally comprise an equalization port for connection to the pressure medium reservoir. Besides the pressure port and the equalization port, the first assembly does not comprise another hydraulic port.

The expansion port of the master brake cylinder may be connected to the equalization port.

The first electrically actuable pressure source may be connected to the equalization port, for example via a non-return valve opening in the direction of the first pressure source, so as to be able to replenish pressure medium. The non-return valve may be arranged in the first assembly.

Alternatively, the first assembly may comprise, in addition to the pressure port, a first equalization port for connection to the pressure medium reservoir and a second equalization port for connection to the pressure medium reservoir. The electrically actuable pressure source may be connected to the first equalization port via a non-return valve opening in the direction of the pressure source. The expansion port of the master brake cylinder may be connected to the second equalization port.

Besides the separation valve, the sequence valve and the simulator valve, the first assembly may not comprise another electrically actuable valve.

Besides an electrically actuable separation valve, by means of which the master brake cylinder is connected to the system pressure line, an electrically actuable sequence valve, by means of which the first pressure source is connected to the system pressure line, and an electrically actuable simulator valve, by means of which the master brake cylinder is hydraulically connected to a simulator arranged in the first assembly, the first assembly does not comprise another electrically actuable valve.

According to one development of the brake system, the second assembly comprises a hydraulic wheel port for each wheel brake for connection to the wheel brakes, an equalization port for connection to the pressure medium reservoir and, in particular only, one pressure port for connection to the first assembly.

The second assembly may comprise at least two, for example at least four, hydraulic wheel ports for connection to the wheel brakes, an equalization port for connection to the pressure medium reservoir and, in particular only, one pressure port for connection to the first assembly.

The pressure port of the second assembly may be connected to the pressure port of the first assembly via a pressure-resistant hydraulic connecting element. For example, the second assembly does not comprise another hydraulic connection.

In the second assembly, a brake supply line connects the, for example at least four, inlet valves to the pressure port of the second assembly and the second pressure source.

The equalization port of the first assembly and the equalization port of the second assembly may be connected to different chambers of the pressure medium reservoir.

The second pressure source may be connected, on the suction side, for example without the interposition of an electrically actuable valve, to the pressure medium reservoir.

The second pressure source may be connected, on the suction side, without the interposition of a valve, to the pressure medium reservoir.

The second pressure source may be connected, via the equalization port of the second assembly, to the pressure medium reservoir.

The pressure port of the first assembly (or the system pressure line) and the second pressure source (or the pressure side thereof) may be connected to a brake supply line to which the, for example at least four, inlet valves are connected.

The second assembly preferably comprises a brake supply line to which the, at least four, inlet valves are connected, and which is (hydraulically) connected to the pressure port of the first assembly (or the system pressure line) and the second pressure source.

The brake system comprises, for each wheel brake, the inlet valve and an outlet valve for adjusting wheel-specific brake pressures, which are derived from the brake supply pressure in the brake supply line, wherein, in the non-activated state, the inlet valves pass the brake supply pressure to the wheel brakes, and the outlet valves block a flow of pressure medium from the wheel brakes.

All the outlet valves may be connected to the pressure medium reservoir which is under atmospheric pressure via a common return line. All the outlet valves may be connected to the equalization port of the second assembly.

The pressure port of the first assembly (or the system pressure line) may be connected to the brake supply line via an electrically actuable second separation valve. The second separation valve may be arranged in the second assembly. The second separation valve may be normally open.

According to one development of the brake system for at least two hydraulically actuable wheel brakes, an electrically actuable circuit separation valve is arranged in the brake supply line in such a way that, when the circuit separation valve is closed, the brake supply line is hydraulically separated into a first line portion and a second line portion, wherein the first line portion is hydraulically connected to the second pressure source and to at least one of the at least two inlet valves, and the second line portion is hydraulically connected to the pressure port of the first assembly and to the other inlet valves.

According to one development of the brake system for at least four hydraulically actuable wheel brakes, an electrically actuable circuit separation valve is arranged in the brake supply line in such a way that, when the circuit separation valve is closed, the brake supply line is hydraulically separated into a first line portion and a second line portion, wherein the first line portion is hydraulically connected to the second pressure source and to at least two of the at least four inlet valves, and the second line portion is hydraulically connected to the pressure port of the first assembly and to the other, for example at least two of the at least four, inlet valves.

The circuit separation valve may be arranged in the second assembly.

The circuit separation valve may be activated by an electronic controller of the second assembly. In the event of a failure of the first assembly, a circuit separation can still be carried out by means of the circuit separation valve.

The circuit separation valve may be normally open, and therefore the circuit separation valve does not have to be activated by means of one of the pressure sources or the master brake cylinder in order to actuate all the wheel brakes.

A first pressure sensor which determines a pressure generated by the master brake cylinder may be arranged in the first assembly.

A second pressure sensor which determines a pressure in the brake supply line, for example a pressure in the second line portion, may be arranged in the second assembly.

A third pressure sensor which determines an inlet pressure of the second assembly may be arranged in the second assembly. The third pressure sensor may be arranged hydraulically in front of the second separation valve, that is to say between the first assembly and the second separation valve.

A second simulator and a second simulator valve may be arranged in the second assembly, wherein the second simulator is connected to the pressure port of the first assembly via the second simulator valve.

According to one development of the brake system, the first assembly comprises a first electronic controller which activates the electrically actuable components of the first assembly, and the second assembly comprises a second electronic controller which activates the electrically actuable components of the second assembly.

The brake system may comprise a first electrical partition and a second electrical partition, which are electrically independent of one another, wherein the first pressure source and the first electronic controller are assigned to the first electrical partition, and wherein the second pressure source, the second electronic controller and the inlet valves, and optionally the circuit separation valve, are assigned to the second electrical partition. The circuit separation valve may be assigned to the second electrical partition. In the event of a failure of the first electrical partition, a circuit separation can thus still be carried out by means of the circuit separation valve.

The first electronic controller or the first electrical partition is preferably supplied with power by a first electrical energy source, and the second electronic controller or the second electrical partition may be supplied with power by a second electrical energy source which is independent of the first electrical energy source. The first energy source is thus part of the first electrical partition, and the second energy source is part of the second electrical partition.

According to one development, the first assembly and the second assembly are interconnected by at most one pressure-resistant hydraulic connecting element. Other non-pressure-resistant connecting elements are possible between the first and second assemblies.

The first assembly and the second assembly may be configured in such a way that they are interconnected by at most one pressure-resistant hydraulic connecting element. Optionally, the first assembly and the second assembly can be interconnected by additional hydraulic connecting elements, but at most one, or only one, of the hydraulic connecting elements is configured to be pressure-resistant between the first and second assemblies. The additional hydraulic connecting elements are then not configured to be pressure-resistant.

The first assembly and the second assembly may be interconnected by only one hydraulic connecting element, wherein this connecting element is configured to be pressure-resistant. Additional non-pressure-resistant connecting elements to the pressure medium reservoir are possible.

Compared with implementation in only one assembly, a division into two assemblies offers that both assemblies are smaller and lighter. However, when divided into two assemblies, each hydraulic connection between these assemblies leads to complexity and costs. Therefore, the number of hydraulic connections may be kept as low as possible. The various functions of hydraulic connections may be separated as clearly as possible. This means that connections via which pressure medium is drawn in can be designed with the largest possible diameter so that they have the smallest possible hydraulic resistance. For this purpose, such connections do not have to be pressure-resistant. Conversely, pressure-bearing connections should not have a suction function.

The first pressure source may be formed by a cylinder-piston arrangement having a hydraulic pressure chamber, the piston of which is advanced and retracted by an electromechanical actuator. A suction port of the first pressure source may be hydraulically connected to the pressure medium reservoir via a non-return valve opening in the direction of the pressure chamber.

The suction side of the second pressure source may be connected to the return line of the outlet valves to the pressure medium reservoir.

The pressure side of the second pressure source may be connected to the first line portion of the brake supply line.

According to one development, the second pressure source has a dual-circuit or multi-circuit configuration. The second pressure source may be in the form of a dual-piston pump or multi-piston pump.

The pressure sides of the dual-circuit or multi-circuit pressure source may be interconnected, and the suction sides of the dual-circuit or multi-circuit pressure source may be interconnected.

The brake system may be suitable for highly automated driving functions.

With respect to the assembly for a brake system for at least two, for example for at least four, hydraulically actuable wheel brakes, is based on the concept that the assembly comprises an electrically actuable pressure source and a master brake cylinder which can be actuated by means of a brake pedal. In this case, the assembly comprises at most one pressure port for transmitting brake pressure to the wheel brakes. For this purpose, the electrically actuable pressure source and the master brake cylinder are hydraulically connected to this pressure port via a system pressure line. In other words, the electrically actuable pressure source and the master brake cylinder which can be actuated by means of a brake pedal are jointly connected to the single pressure port of the assembly to transmit brake pressure in order to actuate the wheel brakes.

The assembly may be cost-effective to produce due to the low number of ports or hydraulic connections.

A pressure medium reservoir under atmospheric pressure may be arranged on the (first) assembly to supply the electrically actuable pressure source and the master brake cylinder with pressure medium.

The (first) electrically actuable pressure source may be connected to the pressure port or the system pressure line via an electrically actuable sequence valve. The sequence valve may configured to be normally closed. Thus in the event of a failure of the electrically actuable pressure source, no pressure medium can flow into the connection to the pressure source.

The (first) assembly may be configured in such a way that, when the brake pedal is not actuated, and the assembly is de-energized, the pressure port is connected to an equalization port of the assembly (100) for connection to a pressure medium reservoir or to a pressure medium reservoir under atmospheric pressure. In such a situation, the pressure port (and thus the wheel brakes connected thereto) are depressurized. The pressure port may be connected to the pressure medium reservoir via the master brake cylinder.

The master brake cylinder may comprise at least one expansion port, via which a pressure chamber of the master brake cylinder is connected to a pressure medium reservoir under atmospheric pressure when the brake pedal is not actuated.

The master brake cylinder or the pressure chamber thereof may be connected to the pressure port or the system pressure line via an electrically actuable separation valve. The separation valve may be configured to be normally open. Besides the separation valve, the hydraulic connection between the master brake cylinder and the pressure port may not have a further electrically actuable valve.

The (first) assembly preferably comprises a simulator which is hydraulically connected to the master brake cylinder. The master brake cylinder may be connected to the simulator via an electrically actuable simulator valve. The simulator valve may be configured to be normally closed. There may not be a non-return valve to allow a flow of pressure medium from the simulator towards the master brake cylinder connected in parallel with the simulator valve.

In addition to the pressure port, the (first) assembly may comprise an equalization port for connection to the pressure medium reservoir.

Besides the pressure port and the equalization port, the (first) assembly may not comprise another hydraulic port.

The expansion port of the master brake cylinder may be connected to the equalization port.

The electrically actuable pressure source may be connected to the equalization port via a non-return valve opening in the direction of the pressure source so as to be able to replenish pressure medium.

Alternatively, the (first) assembly may comprise, in addition to the pressure port, a first equalization port for connection to the pressure medium reservoir and a second equalization port for connection to the pressure medium reservoir. The electrically actuable pressure source may connected to the first equalization port via a non-return valve opening in the direction of the pressure source. The expansion port of the master brake cylinder may be connected to the second equalization port.

Besides the separation valve, the sequence valve and the simulator valve, the (first) assembly may not comprise another electrically actuable valve.

The brake system may comprise an assembly as a first assembly.

### BRIEF DESCRIPTION OF THE DRAWINGS

Further embodiments emerge from the dependent claims and the following description with reference to drawings, in which:

FIG. 1 is a schematic view of an exemplary embodiment of an assembly for a brake system, and

FIG. 2 is a schematic view of an exemplary embodiment of a brake system.

### DETAILED DESCRIPTION

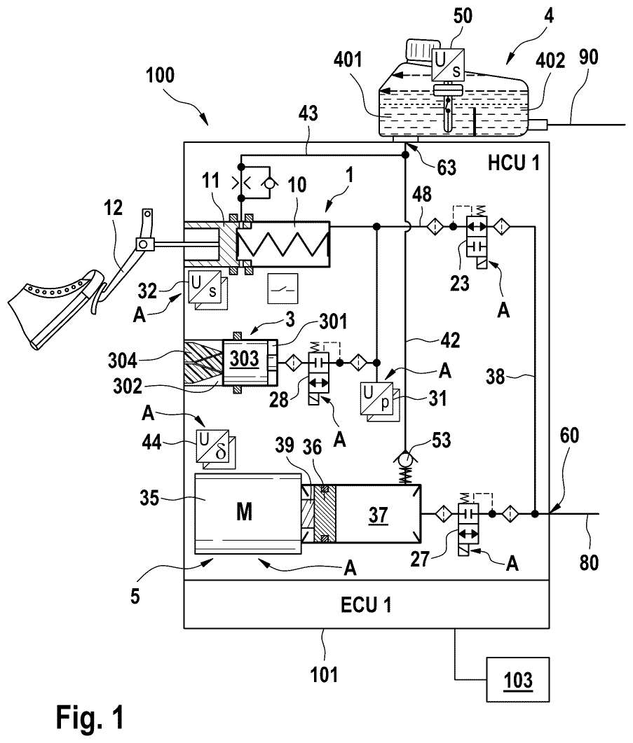

FIG. 1 is a schematic view of an exemplary embodiment of an assembly for a brake system for a motor vehicle.

According to the example, assembly 100 is in the form of an electrohydraulic brake control unit (HECU1) comprising a valve block HCU1 and a first electronic controller 101 (ECU1).

Assembly 100 comprises a (first) electrically actuable pressure source 5 and a master brake cylinder 1, which can be actuated by means of a brake pedal 12.

According to the example, a pressure medium reservoir 4 which is under atmospheric pressure is arranged on the assembly 100.

According to the example, master brake cylinder 1 has a single-circuit configuration and comprises a piston 11 which delimits a hydraulic pressure chamber 10. The pressure chamber 10 is connected to the pressure medium reservoir 4 via radial bores (expansion ports), which are formed in the piston 11, and a corresponding pressure equalization line 43, this hydraulic connection being able to be shut off by a relative movement of the piston 11. The pressure chamber 10 receives a restoring spring which, when the master brake cylinder 1 is not actuated, positions the piston 11 in a starting position. When the brake pedal 12 is not actuated, the pressure chamber 10 of the master brake cylinder 1 is thus connected to the pressure medium reservoir 4 via the expansion ports and the pressure equalization line 43. According to the example, the pressure chamber 10 is connected to a hydraulic equalization port 63 of the assembly 100 which is connected to a first chamber 401 of the pressure medium reservoir 4.

Furthermore, assembly 100 comprises a simulator 3 (also referred to as brake pedal feel simulator or path simulator) to generate a brake pedal feel for the driver, for example in a by-wire operating mode. Simulator 3 is hydraulically coupled to the master brake cylinder 1 and substantially comprises for example a simulator chamber 301, a simulator rear chamber 302, and a simulator piston 303 separating the two chambers 301, 302 from one another. Simulator piston 303 is supported on the valve block of the assembly by a resilient element 304 (for example a simulator spring) arranged in the simulator rear chamber 302. According to the example, the simulator chamber 301 can be connected to the pressure chamber 10 of the master brake cylinder 1 by means of an electrically actuatable simulator valve 28, which is configured to be normally closed. Simulator valve 28 is used to switch the simulator 3 on and off.

The electrically controllable pressure source 5 of the assembly 100 is in the form of a hydraulic cylinder-piston arrangement (or a single-circuit electrohydraulic actuator (linear actuator)), the piston 36 of which can be actuated, in particular advanced and retracted, in order to build up and dissipate a pressure in a pressure chamber 37, by a schematically indicated electric motor 35 via the interposition of a likewise schematically illustrated rotation-translation mechanism 39. The piston 36 delimits the pressure chamber 37 of the pressure source 5. For the activation of the electric motor, a rotor position sensor 44 is provided, which detects the rotor position of the electric motor 35 and which is indicated merely schematically.

Irrespective of the operating state of the piston 36, pressure chamber 37 is connected to the hydraulic equalization port 63 of the assembly 100 via a (replenishment) line 42, which port is connected to the pressure medium reservoir 4 or the first chamber 401 thereof. A non-return valve 53 which closes in the direction of the pressure medium reservoir 4 is arranged in the line 42.

Besides the equalization port 63 and the pressure port 60, the assembly 100 does not comprise any other hydraulic ports.

The pressure source 5 and the master brake cylinder 1 are both connected to a system pressure line 38 which is connected to a pressure port 60 of the assembly 100. Assembly 100 comprises only one pressure port for transmitting brake pressure to the wheel brakes or for actuating the wheel brakes, namely the pressure port 60. The two pressure generators master brake cylinder 1 and electrical pressure source 5, which are designed to generate a brake pressure for actuating the wheel brakes, are connected to this single pressure port 60 of the assembly 100 via the system pressure line 38.

Master brake cylinder 1 or the pressure chamber 10 thereof is connected to the system pressure line 38, and thus the single pressure port 60 of the assembly 100, via an electrically actuable separation valve 23 which is configured to be normally open. Besides the separation valve 23, no further electrically actuable valve is arranged in the hydraulic connection between the master brake cylinder 1 and the pressure port 60.

According to the example, master brake cylinder 1 is connected to the separation valve 23 and the simulator valve 28 by means of a hydraulic line 48.

Pressure source 5 or the pressure chamber 37 thereof is connected to the system pressure line 38, and thus the single pressure port 60 of the assembly 100, via an electrically actuable separation valve 27 which is configured to be normally closed. Pressure source 5 is thus connected to the pressure port 60 in such a way that, in the case of a failure of the pressure source 5, no pressure medium can flow into this connection. According to the example, besides the sequence valve 27, no further electrically actuable valve is arranged in the hydraulic connection between the pressure source 5 and the pressure port 60.

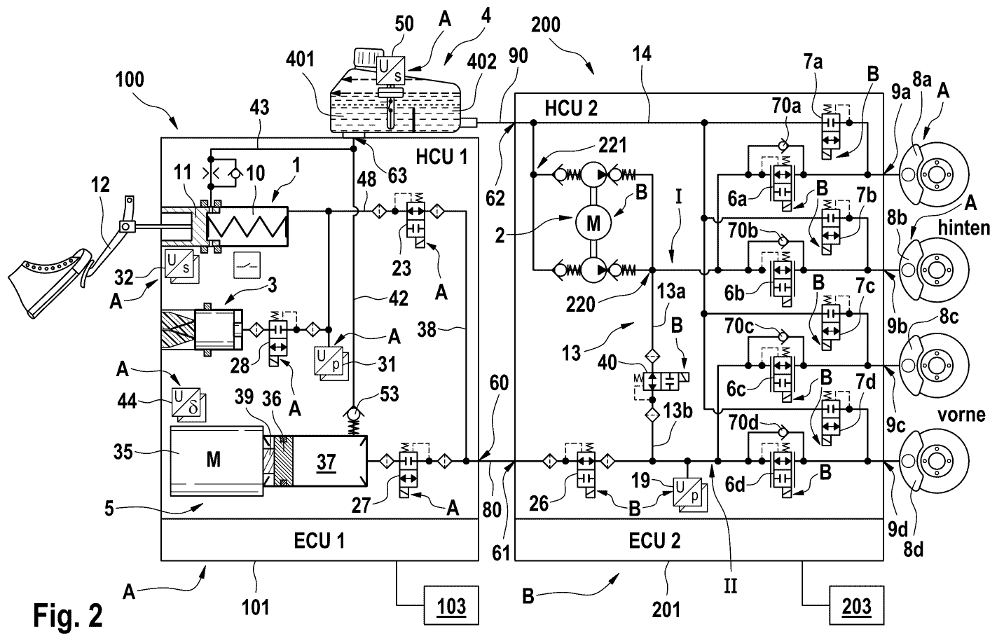

FIG. 2 is a schematic view of an exemplary embodiment of a brake system for a motor vehicle. According to the example, the brake system is designed to actuate four hydraulically actuable wheel brakes 8a-8d. According to the example, the wheel brakes 8a, 8b are assigned to the rear axle (rear) and the wheel brakes 8c, 8d are assigned to the front axle (front) of the vehicle.

The brake system comprises a first assembly 100, which is configured, according to the example, as a first electrohydraulic brake control unit (HECU1) comprising a valve block HCU1 and a first electronic controller 101 (ECU1), and a second assembly 200, which is configured, according to the example, as a second electrohydraulic brake control unit (HECU2) comprising a valve block HCU2 and a second electronic controller 201 (ECU2).

The first assembly 100 from FIG. 2 corresponds to the assembly 100 from FIG. 1.

On the first assembly 100, a pressure medium reservoir 4 comprising two chambers according to the example is arranged, wherein the first chamber 401 is assigned a first reservoir port, and the second chamber 402 is assigned a second reservoir port.

The second assembly 200 comprises a second electrically actuable pressure source 2 and at least one electrically actuable inlet valve 6a-6d per wheel brake, the second electrically actuable pressure source 2 being hydraulically connected to the four inlet valves 6a-6d.

In order to transmit brake pressure for actuating the wheel brakes 8a-8d, the single pressure port 60 of the first assembly 100 is connected to a pressure port 61 of the second assembly 200 via a hydraulic, pressure-resistant connecting element 80. Connection 80 is the only hydraulic pressure connection, according to the example, the only hydraulic connection, between the first assembly 100 and the second assembly 200. It is a hydraulic connection for transmitting a brake pressure to actuate the wheel brakes 8a-8d. Connecting element 80 therefore has to be pressure-resistant.

The pressure port 60, and thus the first pressure source 5 and the master brake cylinder 1, and the second pressure source 2 are connected on the pressure side to a brake supply line 13, to which the four inlet valves 6a-6d are connected. Thus all four wheel brakes 8a-8d can optionally be actuated depending on the operating mode by means of the first pressure source 5 and/or the second pressure source 2 and/or the master brake cylinder 1.

Arranged in the brake supply line 13 is an electrically actuable circuit separation valve 40, and therefore, when the circuit separation valve 40 is closed, the brake supply line 13 is divided into a first line portion 13a, to which the inlet valves 6a, 6b and the wheel brakes 8a, 8b are connected, and a second line portion 13b, to which the inlet valves 6c, 6d and the wheel brakes 8c, 8d are connected. The second pressure source 2 is hydraulically connected to the first line portion 13a, and the pressure port 60, and thus the first pressure source 5 and the master brake cylinder 1, is hydraulically connected to the second line portion 13b. When the circuit separation valve 40 is closed, the brake system is thus separated or divided into two hydraulic brake circuits I and II. In this case, in the first brake circuit I, the pressure source 2 is connected to only the wheel brakes 8a and 8b (via the first line portion 13a) and, in the second brake circuit II, the pressure port 60 or 61 is connected to only the wheel brakes 8c and 8d (via the second line portion 13b). The circuit separation valve 40 is configured to be normally open.

According to the example, the brake system comprises, for each hydraulically actuable wheel brake 8a-8d, an inlet valve 6a-6d and an outlet valve 7a-7d, which are hydraulically interconnected in pairs via central ports and are each connected to a hydraulic wheel port 9a-9d of the second assembly 200, to which the corresponding wheel brake 8a-8d is connected. A non-return valve 70a-70d which opens in the direction of the brake supply line 13 is connected in parallel with each of the inlet valves 6a-6d. The output ports of the outlet valves 7a-7d are connected via a common return line 14 to a hydraulic equalization port 62, which port is connected to the pressure medium reservoir 4 or to the second chamber 402 thereof. The input ports of all the inlet valves 6a-6d can be supplied by means of the brake supply line 13 (that is to say when the circuit separation valve 40 is open) with a pressure which is provided by the first pressure source 5 or, for example in the event of a failure of the first pressure source 5, by the second pressure source 2, or for example in the event of a failure of the first and second pressure source 5, 2, by the master brake cylinder 1 (hydraulic fallback mode).

According to the example, the second electrically controllable pressure source 2 of the second assembly 200 is in the form of a dual-piston pump, the two pressure outputs of which are interconnected (at the pressure side 220 of the pressure source 2) and the two suction sides of which are interconnected (at the suction side 221 of the pressure source 2). The suction side 221 is connected to the return line 14 and thus to the equalization port 62 and the pressure medium reservoir 4. The pressure side 220 is connected to the first line portion 13a of the brake supply line 13.

The equalization port 62, and thus the suction side 221 of the second pressure source 2, is directly connected via a line or a hose 90 to the pressure medium reservoir 4. This connection 90 does not carry any pressure and can therefore have a large diameter. According to the example, line 90 is connected to the second chamber 402 of the pressure medium reservoir 4.

According to the example, an electrically actuable, normally open, separation valve 26 is arranged in the second assembly 200 in addition to the pressure source 2 and the brake pressure modulation valves 6a-6d, 7a-7d. Separation valve 26 is arranged hydraulically between the pressure port 61 of the second assembly 200 and the second line portion 13b of the brake supply line 13. Thus, the pressure port 60 of the first assembly 100 or the system pressure line 38 of the first assembly 100 is separably connected to the second line portion 13b or the brake supply line 13 via the separation valve 26.

According to the example, the brake system comprises, in the brake circuit II (line portion 13b), a pressure sensor 19, which is thus assigned to the second pressure source 2. However, pressure sensor 19 can also be arranged in the brake circuit I, or a second pressure sensor can be provided, so that each of the two brake circuits I and II can be directly monitored by means of a pressure sensor.

According to the example, the brake system comprises, for leakage monitoring purposes, a level-measuring device 50 for determining a pressure medium level in the pressure medium reservoir 4.

According to the example, the components 5, 53, 27, 1, 23, 3, 28 and the line portions 38, 42, 43, 48 are arranged in the first valve block HCU1, and the components 2, 6a-6d, 70a-70d, 7a-7d, 40, 26, 19 and the line portions 13a, 13b, 14 (and the line portions between the inlet and outlet valves, on the one hand, and the wheel ports, on the other hand) are arranged in the second valve block HCU2.

Each valve block HCU1, HCU2 is assigned an electronic controller 101, 201 (ECU1, ECU2). Each electronic controller 101, 201 comprises electrical and/or electronic elements (for example, microcontrollers, power modules, valve drivers, other electronic components, etc.) for activating the electrically actuable components of the associated valve block and optionally the assigned sensors. The valve block and electronic controller are configured in a known manner as an electrohydraulic unit (HECU).

For the electrical attachment, connection and supply of the individual electrical or electrically actuable, activatable, evaluatable or similar components of the brake system, a first electrical partition A and a second electrical partition B are provided, which are electrically independent of one another.

In the drawings, those electrical components which are assigned or belong to the first electrical partition A are indicated by an arrow A, whereas those electrical components which are assigned or belong to the second electrical partition B are indicated by an arrow B.

The electronic controller 101 is assigned or belongs to the first electrical partition A, whereas the second electronic controller 201 is assigned or belongs to the second electrical partition B. Accordingly, the electronic controller 101 and the second electronic controller 201 are electrically independent.

To supply the brake system with electrical energy, a first electrical energy source 103, for example a vehicle electrical system, and a second electrical energy source 203, for example a vehicle electrical system, which is independent of the first energy source, are provided. The first electrical energy source 103 supplies the first electrical partition A with energy, and the second electrical energy source 203 supplies the second electrical partition B.

The first electronic controller 101 activates the first pressure source 5. Accordingly, the first pressure source 5 is assigned to or associated with the first electrical partition A. According to the example, the first pressure source 5 is supplied with energy (from the first electrical energy source 103) via the first electronic controller 101.

The second electronic controller 201 activates the second pressure source 2. Accordingly, the second pressure source 2 is assigned to or associated with the second electrical partition B. According to the example, the second pressure source 2 is supplied with energy (from the second electrical energy source 203) via the second electronic controller 201.

According to the example, the first pressure source 5 can be or is activated exclusively by the first electronic controller 101, and the second pressure source 2 can be or is activated exclusively by the second electronic controller 201.

The remaining components of the brake system are assigned to either the first electronic controller 101 (partition A) or the second electronic controller 201 (partition B). That is to say, said components are activated or actuated by said controller and/or supplied with electrical energy by said controller, and/or are connected on the signal side to said controller and/or are evaluated by said controller. In order to avoid further redundancies, it is the case that a component is activatable or actuable by, or suppliable with electrical energy by, or connected on the signal side to, or evaluatable by, only or exclusively one of the two electronic controllers 101, 201, but not the other electronic controller.

The first electronic controller 101 activates the electrically actuable components of the first assembly 100, and the second electronic controller 201 activates the electrically actuable components of the second assembly 200.

Accordingly, the inlet and outlet valves 6a-6d, 7a-7d are assigned to the second electrical partition B and are activated by the second electronic controller 201. The circuit separation valve 40 is likewise assigned to the second electrical partition B and is activated by the second electronic controller 201.

The separation valve 26 for the hydraulic separation of the first assembly 100 (pressure port 60) and the brake supply line 13 is also assigned to the second electrical partition B and is activated by the second electronic controller 201.

Pressure sensor 19 is also assigned to the second electrical partition B. The signals from said sensor are supplied to the second electronic controller 201 and evaluated and processed thereby.

However, the sequence valve 27, the separation valve 23 and the simulator valve 28 are assigned to the first electrical partition A and are activated by the first electronic controller 101.

Furthermore, the signals from the level measuring device 50 are supplied to the first electronic controller 101 and evaluated and processed thereby.

The brake system preferably comprises electrically actuable parking brakes on the rear wheels (rear). These parking brakes are activated and actuated by the first electronic controller 101 (denoted by A at the wheel brakes 8a, 8b in FIG. 1).

The brake system according to the example comprising a first assembly 100 both allows highly automated driving, in that it contains two electrically activatable pressure sources 5, 2, and also provides a mechanical/hydraulic fallback mode (by means of master brake cylinder 1) in the event of total electrical failure. The first assembly 100 comprises the primary of the two electrically activatable pressure sources (5), a master brake cylinder 1 which the driver can actuate via the brake pedal 12, and a pedal feel simulator 3.

The second assembly 200 according to the example can also be used in combination with a first assembly comprising a single pressure port, which does not comprise a master brake cylinder with a simulator.

However, other second assemblies can also be combined with the first assembly 100 according to the example from FIG. 1.

The first assembly 100 comprises only a single pressure port 60. At the same time, this pressure port 60 can be atmospherically connected, and it is always atmospherically connected when the first assembly 100 has had an electrical failure and the brake pedal 12 is not actuated.

For this purpose, the master brake cylinder 1 may be with an expansion port and is connected to the pressure port 60 via an electrically actuated separation valve 23, which may be normally open. Moreover, the master brake cylinder 1 is connected to the pedal feel simulator 3 via an electrically actuated simulator valve 28, which may be normally closed. The primary pressure source 5 is connected to the pressure port 60, more specifically preferably in such a way that, in the event of a failure of the primary pressure source 5, no pressure medium flows into this connection. An electrically actuated sequence valve 27, which is normally closed, is arranged in this connection.

In normal operation, when the brake pedal 12 is actuated, or when an autopilot wishes to brake, the separation valve 23 is closed, the simulator valve 28 is opened, and the sequence valve 27 is opened. The pedal feel is generated by the pedal feel simulator 3. The pressure buildup for actuating the wheel brakes 8a-8d takes place by means of the two pressure sources 5 and 2 individually or together. Any wheel-specific pressure modulation is carried out by the second assembly 200.

If the second assembly 200 fails, the first assembly 100 builds up the wheel brake pressure in the same manner, and it can centrally modulate the wheel brake pressure for all the wheel brakes 8a-8d together.

After a failure of the first assembly 100, braking is carried out differently by the autopilot and by the driver:

If the first assembly 100 fails and the autopilot transmits a braking request, the second assembly 200 carries out the buildup and the modulation of the wheel brake pressure, correspondingly to how it would take place in a braking system without a mechanical/hydraulic fallback mode.

In the case where the first assembly 100 fails, and the pedal 12 is actuated, after a failure of the first assembly 100, the master brake cylinder 1 is connected to the pressure port 60 of the first assembly 100 via the normally open separation valve 23. During pedal actuation, the second assembly 200 can remain passive and can pass on the pressure which is generated by the driver to the wheel brakes 8a-8d. Depending on the construction of the second assembly 200, however, it is also possible for the driver to be assisted by the second pressure source 2.

In the brake system according to the example from FIG. 2, the electrically actuated circuit dividing valve 40 is closed as soon as the pressure sensor 19 detects a pressure generated by the master brake cylinder 1, and the second pressure source 2 can increase the pressure in the assigned wheel brakes beyond the master brake cylinder pressure.

In order to allow even more functionality when the first assembly 100 fails, the second assembly 200 is optionally supplemented. For example, a (third) pressure sensor can be attached in the pressure connection of the two assemblies 100, 200 (e.g. in front of the separation valve 26 in the second assembly 200) to detect the driver's request. Then, when pressure builds up in the master brake cylinder 1, the sequence valve 26 is closed, and the second pressure source 2 builds up pressure in all the wheel brakes 8a-8d.

Optionally, the pressure connection of the two assemblies 100, 200 can also be attached to a second simulator (pedal feel simulator) via a second simulator valve, which is normally closed, the second simulator valve and the second simulator being arranged in the second assembly 200.

1. A brake system for a motor vehicle for at least two hydraulically actuable wheel brakes comprising:
a first assembly, in which a first electrically actuable pressure source and a master brake cylinder can be actuated by means of a brake pedal;
a second assembly, in which a second electrically actuable pressure source and at least one electrically actuable inlet valve per wheel brake are arranged, the second electrically actuable pressure source being hydraulically connected to the inlet valves
wherein the first assembly comprises at most one pressure port for transmitting brake pressure for actuating the wheel brakes to the second assembly, the first pressure source and the master brake cylinder being connected to the pressure port via a system pressure line.

2. The brake system as claimed in claim 1, wherein all the inlet valves are connected to the single pressure port of the first assembly.

3. The brake system as claimed in either claim 1, wherein the first assembly and the second assembly are interconnected by at most one pressure-resistant hydraulic connecting element, the pressure-resistant hydraulic connecting element being connected to the pressure port of the first assembly.

4. The brake system as claimed in claim 1, wherein, an electrically actuable separation valve, connects the master brake cylinder to the system pressure line, an electrically actuable sequence valve, connects the first pressure source to the system pressure line, and an electrically actuable simulator valve hydraulically connects the master brake cylinder to a simulator arranged in the first assembly, and wherein the first assembly does not comprise another electrically actuable valve.

5. The brake system as claimed in claim 1, wherein the first assembly additionally comprises an equalization port for connection to a pressure medium reservoir under atmospheric pressure, which is arranged on the first assembly.

6. The brake system as claimed in claim 1, wherein the pressure port is connected, by at least one expansion port of the master brake cylinder to a pressure medium reservoir under atmospheric pressure when the brake pedal is not actuated and the first assembly is de-energized.

7. The brake system as claimed in claim 1, wherein the second assembly comprises a hydraulic wheel connection for connection to each wheel brake, an equalization port for connection to a pressure medium reservoir, which is arranged in particular on the first assembly, and only one pressure port for connection to the first assembly, the pressure port of the second assembly being connected to the pressure port of the first assembly.

8. The brake system as claimed in claim 7, wherein the equalization port of the first assembly and the equalization port of the second assembly are connected to different chambers of the pressure medium reservoir.

9. The brake system as claimed in either claim 7 wherein a brake supply line in the second assembly connects the at least two inlet valves to the pressure port of the second assembly and the second pressure source.

10. The brake system as claimed in claim 9, wherein the pressure port of the first assembly is connected to the brake supply line by an electrically actuable second separation valve which is arranged in the second assembly.

11. The brake system as claimed in claim 9 wherein an electrically actuable circuit separation valve in the second assembly is arranged in the brake supply line such that, when the circuit separation valve is closed, the brake supply line is hydraulically separated into a first line portion and a second line portion, the first line portion being hydraulically connected to the second pressure source and to at least one of the at least two inlet valves, and the second line portion being hydraulically connected to the pressure port of the first assembly and to the other of the at least two inlet valves.

12. The brake system as claimed in claim 9, wherein a pressure sensor is arranged in the second assembly, which determines a pressure in the brake supply line.

13. (canceled)

14. An assembly for a brake system comprising:
at least two hydraulically actuable wheel brakes, in which a first electrically actuable pressure source and a master brake cylinder, which can be actuated by means of a brake pedal, are arranged,
the assembly comprises at most one pressure port for transmitting brake pressure to the wheel brakes, the first pressure source and the master brake cylinder being connected to the pressure port by means of a system pressure line.

15. The assembly as claimed in claim 14, wherein the pressure source is connected to the pressure port by an electrically actuable sequence valve.

16. The assembly as claimed in claim 14, further comprising a simulator connected to the master brake cylinder by an electrically actuable simulator valve, and the master brake cylinder is connected to the pressure port by of an electrically actuable separation valve.

17. The assembly as claimed in claim 16, wherein besides the separation valve, no further electrically actuable valve is arranged in the hydraulic connection between the master brake cylinder and the pressure port.

18. The assembly as claimed in claim 16, wherein besides the separation valve, the sequence valve and the simulator valve, the assembly does not comprise another electrically actuable valve.

19. The assembly as claimed in claim 14, wherein the pressure port is connected to an equalization port of the assembly for connection to a pressure medium reservoir when the brake pedal is not actuated and the assembly is de-energized.
